(19) United States
(12) Patent Application Publication
(10) Pub. No.: US 2009/0251057 A1
(43) Pub. Date: Oct. 8, 2009

(54) ARTIFICIAL SOLAR LIGHT SYSTEM USING A LIGHT EMITTING DIODE

(75) Inventors: Won Kuk Son, Ansan-si (KR); Seok Jin Kang, Seoul (KR); Won Cho, Ansan-si (KR)

Correspondence Address: H.C. PARK & ASSOCIATES, PLC, 8500 LEESBURG PIKE, SUITE 7500, VIENNA, VA, 22182, US

(73) Assignee: Seoul Semiconductor Co., Ltd., Seoul (KR)

(21) Appl. No.: 12/306,656

(22) PCT Filed: Jun. 27, 2007
(86) PCT No.: PCT/KR2007/003118

§ 371 Date: Dec. 24, 2008

(30) Foreign Application Priority Data
Jun. 28, 2006 (KR) 10-2006-0058827

(51) Int. Cl. H05B 37/02; F21V 9/00

(52) U.S. Cl. 315/154; 362/231; 315/294

(57) ABSTRACT

The present invention relates to an artificial solar light system, and more particularly, to an artificial solar light system using light emitting diodes. The present invention can provide an artificial solar light system using light emitting diodes, which can represent the same light emission effects as the sun with time. Further, the present invention can provide an artificial solar light system using light emitting diodes, which is inexpensive and is not affected by positions or climate.

### CROSS REFERENCE TO RELATED APPLICATIONS

This application is the National Stage of International Application No. PCT/KR2007/003118, filed Jun. 27, 2007, and claims priority from and the benefit of Korean Patent Application No. 10-2006-0058827, filed on Jun. 28, 2006, which are both hereby incorporated by reference for all purposes as if fully set forth herein.

### BACKGROUND OF THE INVENTION

1. Field of the Invention

The present invention relates to an artificial solar light system, and more particularly, to an artificial solar light system using light emitting diodes.

2. Discussion of the Background

Generally, in places into which solar light is difficult to come, i.e., basements or other closed spaces, various symptoms of side effects (such as undergrowth, skin diseases, and psychological anxieties) may occur due to an insufficient amount of sunshine. Conventionally, as attempt to solve this problem, an artificial solar light system for generating artificial solar light, and a solar light tracking system for allowing real solar light from an outdoor space to directly come into an indoor space through an optical fiber or the like have been constructed.

In the artificial solar light system of the conventional techniques described above, artificial light sources such as incandescent lamps, metal halide lamps or xenon lamps are constructed into a certain module to manufacture a single artificial solar light irradiation apparatus. Since the incandescent lamp has a better color rendering property than any other current light source, it can show spectrum effects of solar light that reaches the earth's surface on a clear sunny day. However, since the incandescent lamp has a color temperature of about 3200 K, it is difficult to represent characteristics of a color temperature of real solar light (from about 3000 K to 7000 K) according to time zones. Further, since color temperature indexes of the metal halide lamp and the xenon lamp are also limited to about 5000 K and 6000 K, respectively, it is impossible to represent the same light emission effects as the sun with time.

Moreover, in the solar light tracking system, a travel path of the sun is tracked, and solar light is collected and received by optical lenses in real time and then introduced into an indoor space through the glass optical fiber. In the solar light tracking system, the plurality of optical lenses are arranged on a solar light collecting surface, a photo sensor is positioned at the center of a lens module, and a program is installed in a microprocessor to automatically rotate a solar light collecting surface module in real time according to the travel path of the sun. The conventional solar light tracking system described above has advantages in that the solar light tracking system can receive the energy of real solar light as it is and a harmful wavelength can be removed from the solar light by using a specific filter. However, there is a disadvantage in that the solar light tracking system cannot be used in the rainy season or on cloudy days. Further, since the optical lenses should be positioned outdoors to receive the solar light, they require special care in maintenance. Further, the solar light should be collected by the optical lenses and then transmitted into an indoor space through the optical fiber. In this case, a glass optical fiber with a superior thermal property rather than an inexpensive resin-based optical fiber should be used as the optical fiber. However, since a small-sized glass optical fiber on the order of microns causes great loss, there is a problem in that an expensive glass optical fiber with a diameter of 1 mm or more should be employed. Moreover, since the optical lenses are typically mounted on the roof of a building, costs accordingly increase due to the increased length of the glass optical fiber to be used and a loss fraction also increases due to an increased distance, resulting in limitations on the installation and use thereof.

### SUMMARY OF THE INVENTION

The present invention is conceived to solve the aforementioned problems in the prior art. Accordingly, an object of the present invention is to provide an artificial solar light system using light emitting diodes, which can represent the same light emission effects as the sun with time.

Further, another object of the present invention is to provide an artificial solar light system using light emitting diodes, which is inexpensive and is not affected by positions or climate.

To achieve these objects, the present invention provides an artificial solar light system using light emitting diodes, comprising a plurality of light emitting diode modules having different color temperatures; and a control unit for controlling the plurality of light emitting diode modules.

The artificial solar light system of the present invention may further comprise a diffusion globe arranged in front of the plurality of light emitting diode modules so as to mix light emitted from the plurality of light emitting diode modules and to irradiate the mixed light.

At this time, the plurality of light emitting diode modules may be alternately arranged.

The plurality of light emitting diode modules may have a color temperature of 3000 K to 7000 K. The control unit may comprise a memory unit for storing data on changes in a color temperature and optical properties of the sun with time; and a microprocessor for controlling currents applied to the respective light emitting diode modules having different color temperatures by using the data on changes in the color temperature and optical properties of the sun with time, which have been stored in the memory unit.

At this time, the memory unit may further include solar coordinate system information according to periods of earth's rotation and revolution, and the microprocessor may control the light emitting diode modules by using the data on changes in the color temperature and optical properties of the sun with time and the solar coordinate system information, which have been stored in the memory unit.

At this time, the microprocessor may receive information on a position and control the light emitting diode modules by using the data on changes in the color temperature and optical properties of the sun with time and the solar coordinate system information, which have been stored in the memory unit, depending on the position information.

Alternatively, the control unit may further comprise a global positioning system for identifying a position of the artificial solar light system; and the microprocessor may control the light emitting diode modules by using the data on changes in the color temperature and optical properties of the sun with time and the solar coordinate system information, which have been stored in the memory unit, depending on the position identified by the global positioning system.

According to the present invention described above, it is possible to provide an artificial solar light system using light emitting diodes, which can represent the same light emission effects as the sun with time.

Further, the present invention can provide an artificial solar light system using light emitting diodes, which is inexpensive and is not affected by positions or climate.

### BRIEF DESCRIPTION OF THE DRAWINGS

FIG. 1 is a conceptual view showing an artificial solar light system using light emitting diodes according to a first embodiment of the present invention.

FIG. 2 is a plan view showing a light source module in the first embodiment of the present invention.

FIG. 3 is a conceptual view showing an artificial solar light system using light emitting diodes according to a second embodiment of the present invention.

### DETAILED DESCRIPTION OF THE ILLUSTRATED EMBODIMENTS

The present invention is not limited to embodiments set forth below but can be implemented in different forms. The embodiments are provided for complete disclosure of the present invention and for fully conveying the scope of the present invention to those skilled in the art. Like reference numerals in the drawings indicate like elements.

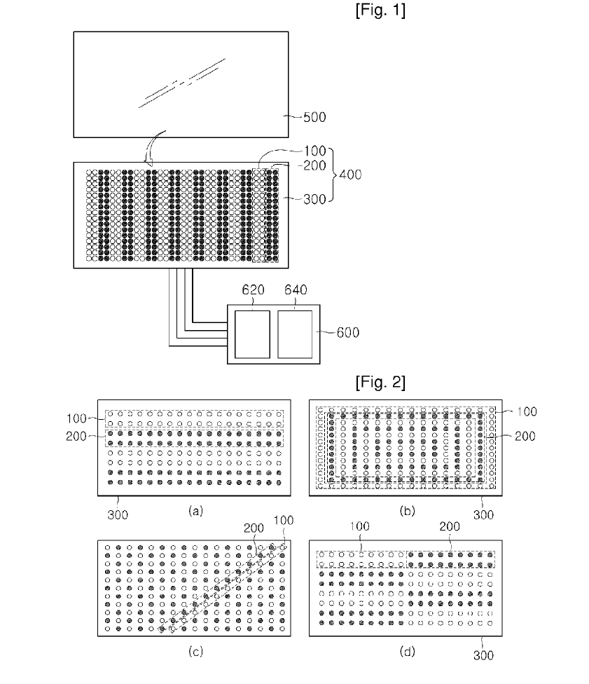

FIG. 1 is a conceptual view showing an artificial solar light system using light emitting diodes according to a first embodiment of the present invention.

As shown in FIG. 1, the artificial solar light system using light emitting diodes according to the first embodiment of the present invention includes a light source module 400, a diffusion globe 500 provided on the light source module 400, and a control unit 600 for controlling the light source module 400.

The light source module 400 serves as a light source for the artificial solar light system using light emitting diodes according to the present invention, and includes a base plate 300 and first and second light emitting diode modules 100 and 200 that are mounted on the base plate 300.

The base plate 300 is used for fixedly mounting the first and second light emitting diode modules 100 and 200 thereon, and may be constructed to be in the form of a conventional substrate, i.e., to have a structure with an electrode pattern formed on an insulator. The first and second light emitting diode modules 100 and 200 are mounted on the base plate 300 so as to be connected to the electrode pattern that in turn is connected to an external power supply, so that the first and second light emitting diode modules 100 and 200 can be operated. The shape of the base plate 300 may be variously changed depending on the object and use of the artificial solar light system using light emitting diodes. That is, although the base plate 300 is made in the form of a rectangular plate in this embodiment, the present invention is not limited thereto. The base plate 300 may be in the form of a circular or polygonal plate. Alternatively, the base plate 300 may be in the form of a cylindrical or polygonal post, or a sphere. The shape of the base plate 300 is not limited thereto so far as it meets the object of the present invention.

The first and second light emitting diode modules 100 and 200 include first and second light emitting diode modules 100 and 200 having a color temperature of 3000 K to 7000 K.

At this time, the first light emitting diode module 100 may include a plurality of light emitting diodes having a color temperature of about 3000 K to 5000 K, while the second light emitting diode module 200 may include a plurality of light emitting diodes having a color temperature of about 5000 K to 7000 K. However, the present invention is not limited thereto but may further include a third light emitting diode module. That is, for example, it is possible to employ a first light emitting diode module having a color temperature of about 3000 K to 4500 K, a second light emitting diode module having a color temperature of about 4500 K to 6000 K, and a third light emitting diode module having a color temperature of about 6000 K to 7000 K. As described above, the present invention may employ at least two light emitting diode modules of which color temperatures range from 3000 K to 7000 and are different from each other. At this time, the respective color temperature ranges of the light emitting diode modules may overlap with each other at their boundary regions.

Each of light emitting diodes of the first and second light emitting diode modules 100 and 200 described above includes a light emitting chip and a phosphor. The light emitting chip and the phosphor may be implemented in various manners. For example, the light emitting diode may include a single blue light emitting chip capable of blue light and a yellow phosphor capable of emitting yellow light. That is, the blue light emitted by the blue light emitting chip and the yellow light obtained through wavelength conversion of the phosphor are mixed to implement white light.

Further, the light emitting diode may include a single blue light emitting chip capable of emitting blue light, and a green phosphor capable of emitting green light, and an orange phosphor capable of emitting orange light. At this time, the blue light emitted by the blue light emitting chip, and the green and orange light obtained through wavelength conversion of the phosphors are mixed to implement white light. In this case, there is an advantage in that better color rendering property can be obtained than the light emitting diode including the blue light emitting chip and the yellow phosphor. That is, it is possible to improve the color rendering property by using a light emitting chip and a plurality of kinds of phosphors with various light emission peaks. If a plurality of kinds of phosphors are used, it is possible to implement white light having a different color temperature and color rendering property depending on not only the composition of each of the phosphors but also the composition ratio of the phosphors. It is preferred that a blue light emitting chip or an ultraviolet light emitting chip be used as the light emitting chip in the present invention.

A series of materials with various light emission peak ranges, e.g., silicate-based phosphors with a light emission peak range from green to red, may be used as the phosphor in the present invention. That is, light emitted by the light emitting chip can be used as an excitation source for implementing various colors, thereby implementing white light with a different optical spectrum and color temperature characteristic. Further, if a plurality of kinds of phosphors are included, an identical series of materials may be used to minimize influences among the phosphors.

The first light emitting diode modules 100 and the second light emitting diode modules 200 for certain light that is distinguished from each other according to color temperatures as described above are alternately arranged to construct the single light source module 400. When the light source module 400 is constructed, the light emitting diode modules with certain color temperature ranges are classified according to predetermined range intervals as described above, and modularized respectively. In this embodiment, the first and second light emitting diode modules 100 and 200 are arranged in two columns as shown in FIG. 1. However, the first and second light emitting diode modules are not limited thereto but may be arranged in more or less than two columns. Further, the first and second light emitting diode modules 100 and 200 are alternately arranged in FIG. 1 but are not limited thereto. That is, as shown in FIG. 2(a), the first and second light emitting diode modules 100 and 200 may be arranged in rows rather than in columns. Alternatively, as shown in FIG. 2(b), the first and second light emitting diode modules 100 and 200 may be arranged in the form of bands. Alternatively, the first and second light emitting diode modules 100 and 200 may be arranged in a diagonal direction as shown in FIG. 2(c), or may be arranged alternately in both row and column directions as shown in FIG. 2(d). Furthermore, although not shown in the figures, a plurality of first light emitting diode modules 100 may be arranged at one side of the base plate 300 while a plurality of second light emitting diode modules 200 may be arranged at the other side of the base plate 300, or the first and second light emitting diode modules 100 and 200 may be randomly arranged. However, it is preferred that identical numbers of the first and second light emitting diode modules 100 and 200 be alternately arranged so that the artificial solar light system can represent a constant color temperature as a whole.

The control unit 600 is to accurately operate the light source module 400, and includes a memory unit 640 for storing data on changes in the color temperature and optical properties of the sun with time, and a microprocessor 620 for controlling the respective light emitting diode modules with different color temperatures by using the data. That is, the microprocessor 620 performs control of currents for the respective light emitting diode modules so as to respond to the changes in the color temperature and optical properties of the sun with time. Such current control allows the light source module 400 to emit light that has properties similar to those of spectrum variations of real solar light. However, the present invention is not limited thereto. A switchover to a manual mode may be performed if a user wants to use a wavelength in a specific color temperature range.

Further, the artificial solar light system of the present invention can be changed in size depending on a use of the light source module 400. That is, the size of the artificial solar light system can be increased or decreased according to both the number of the light emitting diode modules and the number of the light emitting diodes provided in the light source module 400.

The diffusion globe 500 is to mix light emitted from the light emitting diode modules, and is arranged in front of the light emitting diode modules. The diffusion globe 500 is made of a material having a superior light transmission property, and functions to mix differences in color senses of the respective light emitting diode modules having different color temperatures so as to smooth differences in chromaticity. The diffusion globe 500 described above may be eliminated depending on the object and use of the artificial solar light system.

As described above, a plurality of light emitting diodes with a color temperature of about 3000 K to 5000 K are used for the first light emitting diode module 100, and a plurality of light emitting diodes with a color temperature of about 5000 K to 7000 K are used for the second light emitting diode module 200, so that the artificial solar light system of the present invention has a color temperature distribution of about 3000 K to 7000 K, which is similar to that of the sun. In the light emitting diode modules with the color temperature distribution described above, light emitting diode modules with similar color temperatures are grouped and provided with an independent power line.

In the light source modules provided with the independent power line as described above, the magnitude of a current is adjusted such that a higher current is applied to light emitting diodes having a color temperature property corresponding to a change in sunshine while a lower current is applied to the other light emitting diodes, thereby controlling the overall color temperature. That is, for example, in the morning, a higher current is applied to the first light emitting diode module 100 with a lower color temperature while a lower current is applied to the second light emitting diode module 200. Meanwhile, at noon, an identical current is applied to the first and second light emitting diode modules 100 and 200. Further, in the afternoon, a lower current is applied to the first light emitting diode module 100 while a higher current is applied to the second light emitting diode module 200.

As described above, the artificial solar light system of the present invention can correspond to changes in properties of the sun with time and to the travel property of the sun by employing light emitting diodes having a color temperature similar to that of the solar light and providing the control unit 600 for controlling the light emitting diodes. Further, since it is not required to provide an optical lens, which should have been installed outdoors to receive solar light, and an optical fiber for transmitting the solar light received by the optical lens, the artificial solar light system can be operated as desired regardless of changes in climate and can also be easily moved and managed. Accordingly, an expensive component such as the optical fiber is not required, and thus, there is no optical transmission loss due to the optical fiber.

According to the artificial solar light system using the light emitting diodes described above, it is possible to construct a light source for representing a spectrum similar to that of real solar light, and the light source can be applied to bio-industry, plant growth in indoor and underground environments, agriculture, and a region with insufficient sunshine such as an aquarium in which high-grade fish are brought up and displayed. Further, the artificial solar light system can be applied to illumination equipment for a dermatological patient, facilities such as an intensive care unit for a patient who cannot easily move, and the like. Moreover, the artificial solar light system can be applied to indoor decoration for image design, a psychical cure, beauty treatment, medical treatment, and the like.

Next, an artificial solar light system using light emitting diodes according to a second embodiment of the present invention, which includes a global positioning system (GPS), will be described with reference to the drawings. Portions of this embodiment overlapping with those of the previous embodiment will not be described or will be briefly described.

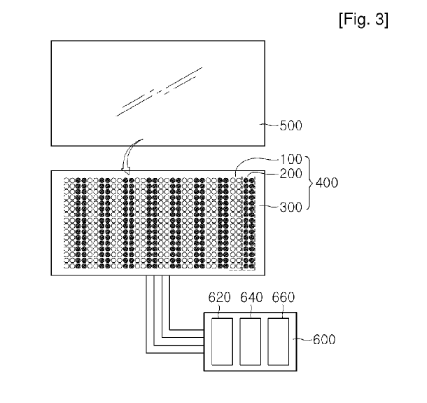

FIG. 3 is a conceptual view showing the artificial solar light system using light emitting diodes according to the second embodiment of the present invention.

As shown in FIG. 3, the artificial solar light system using light emitting diodes according to the second embodiment of the present invention includes a light source module 400, a diffusion globe 500 provided on the light source module 400, and a control unit 600 having a global positioning system 660 for controlling the light source module 400. At this time, the diffusion globe 500 may be eliminated, if necessary.

The control unit 600 is to operate the light source module 400, and includes a memory unit 640 for storing data on changes in the color temperature and optical properties of the sun with time, a microprocessor 620 for controlling the respective light emitting diode modules with different color temperatures by using the data, and the global positioning system 660 for identifying the position of the artificial solar light system.

That is, the artificial solar light system employs the global positioning system 660 to detect a position where the artificial solar light system is installed. With the detection of the position, the microprocessor 620 performs control of currents for the respective light emitting diode modules so that the artificial solar light system can correspond to changes in the color temperature and optical properties of the sun according to time and installation positions. The current control allows the light source module 400 to emit light having properties similar to changes in a spectrum of real solar light in a region where the artificial solar light system is installed.

When the global positioning system 660 is employed in the artificial solar light system as described above and the memory unit 640 stores solar coordinate system information according to periods of earth's rotation and revolution, the artificial solar light system of the present invention has solar light emission properties which meet regional features all over the world. Since the solar light emission properties are changed depending on the latitude and longitude of a required region, for example, the winter in the northern hemisphere of the earth corresponds to the summer in the southern hemisphere thereof, the operational properties of the artificial solar light system are required to meet the solar light emission properties. As complementary measures for meeting the requirements, the global positioning system 660, which is inexpensive and of which a radio frequency channel is open all over the world is provided, the memory unit 640 stores the travel path of the sun (solar light emission properties) according to position information over the world and position information on a corresponding region, and the microprocessor 620 operates the light source module 400, as described above. Accordingly, it is possible to make more effective artificial solar light optimized to environments. However, the artificial solar light system of this embodiment is not limited thereto but may be operated to irradiate natural light of an environment to which a user is accustomed. That is, for example, if solar light similar to that in the spring in Korea is intended to be irradiated in the Arctic zone, the function of the global positioning system 660 is suspended and the latitude and longitude of Korea in March are inputted as the position information, so that artificial solar light corresponding thereto can be irradiated. Further, since it is not easy for people to comfortably receive solar light energy outdoors because of serious environmental pollution all over the world, the installation and operation of the artificial solar light system of the present invention on the ceiling of a desired room allows a user to safely receive light irradiation, which is similar to outdoor solar light, in an indoor environment.

Although the present invention has been described in connection with the embodiments and with reference to the drawings, it can be understood by those skilled in the art that the present invention can be variously modified and changed without departing from the technical spirit of the present invention defined by the claims.

1. An artificial solar light system using light emitting diodes, comprising:
a plurality of light emitting diode modules having different color temperatures; and
a control unit to control the plurality of light emitting diode modules.

2. The artificial solar light system as claimed in claim 1, further comprising a diffusion globe arranged in front of the plurality of light emitting diode modules so as to mix light emitted from the plurality of light emitting diode modules and to irradiate the mixed light.

3. The artificial solar light system as claimed in claim 2, wherein the plurality of light emitting diode modules are alternately arranged.

4. The artificial solar light system as claimed in claim 1, wherein the plurality of light emitting diode modules have a color temperature of 3000 K to 7000 K.

5. The artificial solar light system as claimed in claim 1, wherein the control unit comprises:
a memory unit to store data on changes in a color temperature and optical properties of the sun with time; and
a microprocessor to control currents applied to the respective light emitting diode modules having different color temperatures by using the data on changes in the color temperature and optical properties of the sun with time, which have been stored in the memory unit.

6. The artificial solar light system as claimed in claim 5, wherein the memory unit further comprises solar coordinate system information according to periods of earth's rotation and revolution, and the microprocessor controls the light emitting diode modules by using the data on changes in the color temperature and optical properties of the sun with time and the solar coordinate system information, which have been stored in the memory unit.

7. The artificial solar light system as claimed in claim 6, wherein the microprocessor receives information on a position and controls the light emitting diode modules by using the data on changes in the color temperature and optical properties of the sun with time and the solar coordinate system information, which have been stored in the memory unit, depending on the position information.

8. The artificial solar light system as claimed in claim 6, wherein the control unit further comprises a global positioning system to identify a position of the artificial solar light system, and the microprocessor controls the light emitting diode modules by using the data on changes in the color temperature and optical properties of the sun with time and the solar coordinate system information, which have been stored in the memory unit, depending on the position identified by the global positioning system.
